(19) United States
(12) Patent Application Publication
(10) Pub. No.: US 2015/0159822 A1
(43) Pub. Date: Jun. 11, 2015

(54) GLASS CONTAINER AND CHARGING STATION

(71) Applicant: Alexander Mohr, Donauworth (DE)

(72) Inventor: Alexander Mohr, Donauworth (DE)

(21) Appl. No.: 14/408,379

(22) PCT Filed: Nov. 15, 2013
(86) PCT No.: PCT/EP2013/073913

§ 371 Date: Mar. 2, 2015

(30) Foreign Application Priority Data
Nov. 28, 2012 (DE) 20 2012 104 619.9

(51) Int. Cl. F21L 4/08; H02J 7/35; H02J 7/02; H02J 7/00; F21V 31/00; F21V 33/00

(52) U.S. Cl. CPC F21L 4/08; F21V 31/00; F21V 33/0036; H02J 7/025; H02J 7/0052; H02J 7/35; F21Y 2101/02

(57) ABSTRACT

The invention relates to a glass container (1) with a lighting module (6) including at least one illuminant (12, 12′) and an electrical energy store (9), which are connected to a triggering circuit (8) for activating the illuminant (12, 12′), and further relates to a charging station for such a glass container. The invention solves the problem of providing a glass container having a light that allows a long usage of the light in the glass container and of the glass container itself, easy charging of the energy store and easy activation of the lighting module in that a charging device (17) for charging the electrical energy store (9) is provided in the glass container (1) and in that the charging station has an energy transfer device for transferring energy to the charging device (17) of the glass container (1).

The invention concerns a glass container according to the preamble of claim 1 and a charging station for such a glass container according to the preamble of claim 14.

In the state of the art, glass containers in the form of drinking glasses are known, which have a lighting module in the standing base of the drinking glass. The lighting module thereby has several light-emitting diodes, which, in part, emit light differently and which are supplied with voltage from a battery and are triggered via a triggering circuit. The lighting module is thereby connected with the electrically conductive walls of the drinking glass in such a way that the circuit for the light-emitting diodes is only closed with several fingers touching the walls. The lighting module is thereby firmly integrated into the drinking glass, for example, affixed through molding, melting, or by means of invisible adhesive strips. As soon as the battery is discharged, the lighting module and thus the drinking glass are useless. Often, the drinking glass is then simply discarded.

From DE 200 03 533 U1, a drinking vessel is known that has a vessel section suitable for holding a beverage and another foot section producing a secure standing base for the vessel, wherein a lighting and/or blinking device is/are placed in the vessel.

A drinking glass is likewise known from DE 299 18 185 U1, which is to be combined with a lighting device, so that the liquid found in the liquid container can be immersed in light. The lighting device can thereby have a manually actuatable switch, a proximity switch, a twilight switch, a time switch, an acoustical sensor, a vibration sensor, a position sensor, a contact sensor, a motion sensor, a pressure sensor, a temperature sensor, and/or a humidity sensor to switch on and/or off the light or an illuminant.

DE 20 2007 010 521 U1 discloses a flat, actively shining element, consisting of a solar cell and a glass plate, which is connected with the solar cell by means of a plastic material. Illuminants are introduced into the plastic material; they are supplied with electrical energy via a conducting, structured layer that is located on the glass plate. The switching on and off of the illuminants is carried out there via a twilight switch automatically or manually via controls.

Therefore, the goal of the invention is make available a glass container with light, which overcomes the aforementioned disadvantages and makes possible a long use of the light of the glass container and of the glass container itself, and permits an easy charging of the energy storage unit and an easy activation of the lighting module.

The invention attains this goal with a glass container with the features of claim 1 and a charging station with the features of claim 14. Advantageous developments and appropriate refinements of the invention are indicated in the subclaims.

A glass container, mentioned in the beginning, is characterized in accordance with the invention in that a charging device is provided in the glass container so as to charge the electrical energy storage unit, in particular, a battery.

Advantageously, the charging device can be a solar cell placed in or on the glass container, so that with a proper placement of the glass container, the charging of the energy storage unit can be carried out already via natural or artificial light sources, such as the room lighting.

Furthermore, the charging device can advantageously have a coil for the inductive transfer of electrical energy from an additional coil, located outside the glass container, to a charging station, so as to charge the energy storage unit independently of the ambient lighting.

Preferably, the lighting module can be integrated into the glass container in order to make possible an attractive shape and a use free of injuries. In particular, the lighting module can be integrated water-tight into the glass container, so that the glass container can be washed in the dishwasher. Preferably, the glass container can be a drinking glass or a vase with a standing base and a lighting module integrated therein.

In one advantageous development, the solar cell can be located in the standing base, wherein the solar cell can preferably point toward the underside of the standing base. In this way, by turning the glass container upside down, the solar cell can be easily radiated by the ambient lighting, for example, a ceiling light, and thus the energy storage unit can be charged.

Preferably, the glass container can be made of electrically conductive glass and for the activation of the illuminant, an electrical circuit between the illuminant, the triggering circuit, and the electrical energy storage unit can be closed by touching the glass container with at least one body part of the user of the glass container. The glass can thereby have an electrically conductive coating, connected with the triggering circuit, wherein, preferably, two contact terminals of different polarities are connected with parts of the electrically conductive coating, electrically separate from one another.

In one advantageous embodiment, the contact surfaces can run around walls of the glass container and, like a comb, have teeth meshing into one another. In an alternative advantageous embodiment, the contact surfaces are designed as half-cylinders which do not touch one another, and run halfway around walls and/or the standing base of the glass container.

A charging station, mentioned in the beginning, is characterized in accordance with the invention in that the charging station has an energy transfer device for the transfer of energy to the charging device of the glass container.

Preferably, the energy transfer device can have a lighting unit for the radiation of the solar cell, located on the glass container, which is described above and in the following. In an alternative or additional embodiment, the energy transfer device can be a primary coil for the inductive transfer of electrical energy to a coil of the glass container, which is described above and in the following.

Additional features and advantages of the invention can be deduced from the following description of a preferred embodiment example, with the aid of the drawings. These figures show the following:

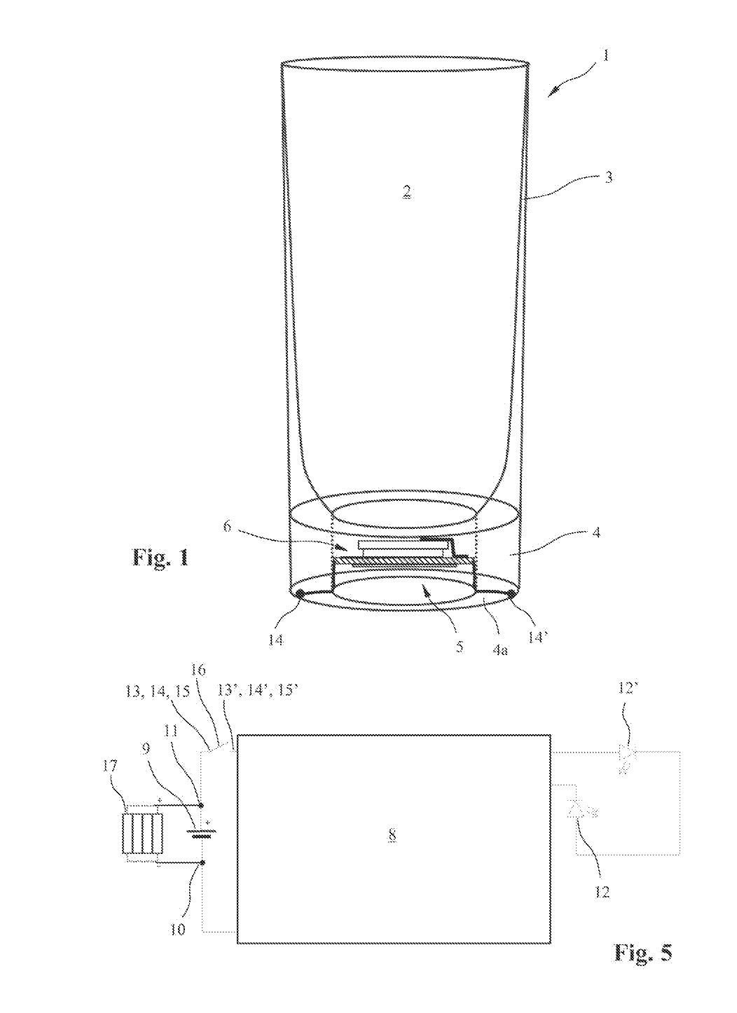

FIG. 1, a schematic, three-dimensional, transparent view of a glass container in accordance with the invention;

FIG. 2, a schematic side view of a lighting module of the glass container from FIG. 1;

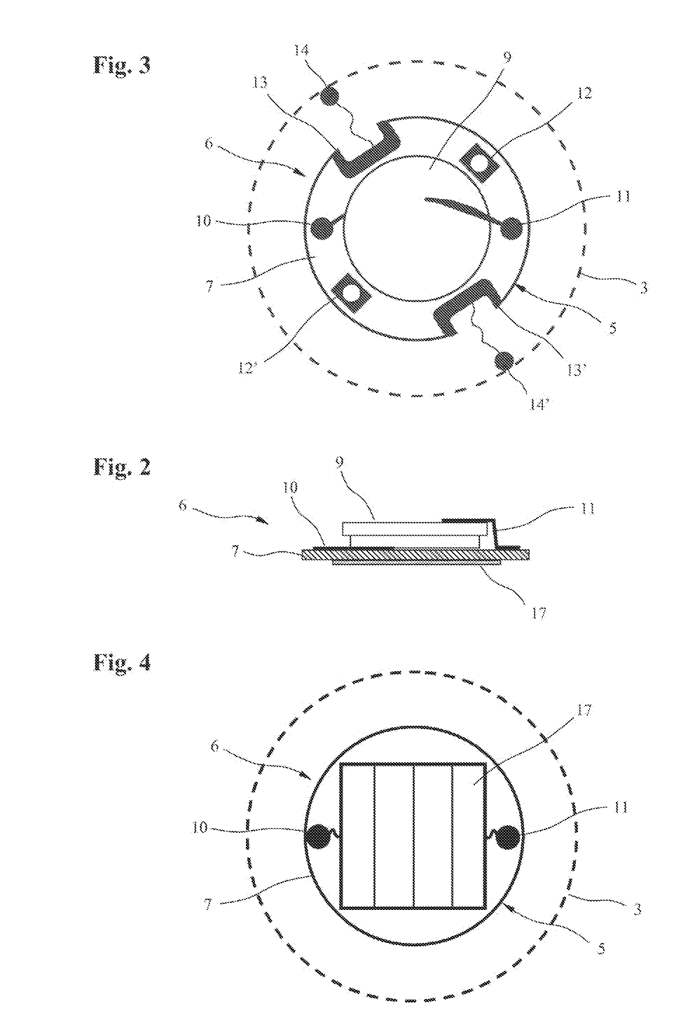

FIG. 3, a top view of the lighting module from FIG. 2;

FIG. 4, a view of the lighting module from FIG. 2, from below in FIG. 2;

FIG. 5, an electrical block diagram of the lighting module:

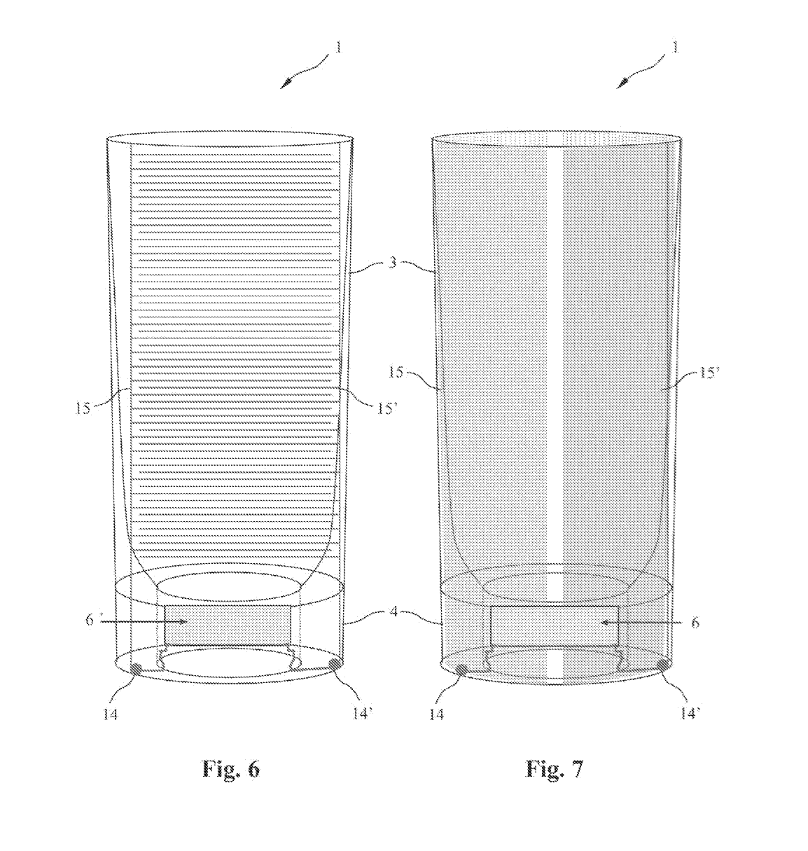

FIG. 6, a schematic, three-dimensional view of the glass container from FIG. 1 with a first embodiment of contact surfaces;

FIG. 7, a schematic, three-dimensional view of the glass container from FIG. 1 with a second embodiment of contact surfaces.

FIG. 1 shows a schematic, three-dimensional, transparent view of a glass container in accordance with the invention, in the form of a drinking glass 1. Here, the drinking glass 1 is made of glass, but it can also be made of plastic glass, for example, acrylic glass. In a manner which is, in fact, known, the drinking glass 1 has a holding space 2 for a beverage, which is surrounded by walls 3 and is closed off below by a standing base 4 with a bottom surface 4a.

In the standing base 4, a cylindrically shaped trough 5, open downward, into which a lighting module 6, which serves to illuminate the drinking glass 1 and particularly the holding space 2, is pressed and is firmly molded therein. Preferably, the lighting module 6 is molded liquid-tight into the trough 5, glued in, or stuck with a transparent, nonvisible adhesive strip, so that the drinking glass 1 can also be washed in a dishwasher. In an alternative embodiment, the trough can be opened upward or even extend entirely through the standing base 4, wherein in both cases, at least the area closing the holding space below 2 must be liquid-tight.

The lighting module 6 is explained in detail with the aid of FIGS. 2-4, wherein in FIGS. 3 and 4, the components of the drinking glass 1 that surround the lighting module 6 are alluded to schematically, for a better understanding.

The lighting module 6 has a triggering circuit 8, which is shown in FIG. 5 and is essentially located on a circular circuit board 7.

A rechargeable battery 9 is placed as an electrical energy storage unit on the upper side of the circuit board 7. The battery 9 contacts a negative terminal contact 10 with its negative terminal, and is held on the circuit board 7 by means of an upper-side, bow-shaped, positive terminal contact 11, which contacts the positive terminal of the battery 9.

Furthermore, as shown in FIG. 3, two illuminants, designed as light-emitting diodes 12, 12′, are placed on the upper side of the circuit board 7, for example, in the form of known SMD light-emitting diodes. The light-emitting diodes 12, 12 are connected in series and connected with an outlet of the triggering circuit 8, in the manner shown in FIG. 5.

From the upper side of the circuit board 7, thin wires go from two contact surfaces 13, 13′, located on the circuit board 7, to two contact terminals 14, 14′, which on the bottom surface 4a of the drinking glass 1 preferably go to the walls 3 of the drinking glass 1 via a transparent, circular adhesive, which is not shown in the drawings, so as to bring about an electrically conducting connection to the walls 3 and standing base 4 made from an electrically conductive glass. The reason for this is that with the drinking glass 1, the light-emitting diodes 12, 12′ are to illuminate only when a person takes hold of the drinking glass 1 and preferably makes contact with one or two body parts, for example, two fingers or the palm of the hand and a finger. Disregarding the actual physical mode of functioning in the schematic of FIG. 5, this switching function is shown, simplified, as a switching element 16.

The switching element 16 can, for example, be implemented with a contact-sensitive sensor or a switch that, for example, detects the change of the capacity of the electrically conductive glass when it is touched by the person and produces the connection between the battery 9 and the light-emitting diodes 12, 12′, perhaps via the triggering circuit 8.

Alternatively, the drinking glass 1 can also have two electrically conducting contact surfaces 15, 15′, which are electrically separate from one another as shown in FIGS. 6 and 7. The contact surface 15 is thereby connected with the contact terminal 14 in an electrically connecting manner, and the other contact surface 15′, with the contact terminal 14′.

Preferably, the contact surfaces 15, 15′ of the drinking glass 1 can be designed as an electrically conductive, largely transparent coating, in particular, an indium tin oxide (ITO) coating, which is placed on the walls 3 of the drinking glass 1, as shown in FIGS. 6 and 7.

Alternatively, the glass of the drinking glass 1 can be made electrically conductive during production with the admixture of ITO, especially if the switching element is designed as a capacitive sensor, in which only one contact surface is placed on the walls 3.

The electrically conducting contact surfaces 15, 15′, which are electrically separated from one another, are thereby designed in such a way that upon grasping the drinking glass 1, a connection is produced between the two contact surfaces 15, 15′, and thus also between the contact terminals 14, 14′. Preferably, the two contact surfaces 15, 15′ can surround the walls 3 and, like a comb, can have teeth meshed into one another, as alluded to schematically in FIG. 6, so that the connection is guaranteed when a person touches the walls 3. In this embodiment, it is already sufficient if, for example, contact is made with a finger, next to “teeth” of the contact surfaces 15, 15′, which have teeth like a comb, and are thus connected in an electrically conducting manner.

In the alternative embodiment shown in FIG. 7, the contact surfaces 15, 15′ are designed as half-cylinders that do not touch each other and run halfway around the walls 3 and the standing base 4 of the drinking glass 1. Since the drinking glass 1 is, as a rule, grasped from both sides, for example, with the thumb and the fingers of one hand, an electrically connecting connection is also produced and thus, the switching element 16, in accordance with FIG. 5, is closed.

The lighting module 6 can be preferably molded in a transparent plastic, which is adapted to the shape of the trough 5. Only the contact terminals 14, 14′ are then brought out, which are connected with the electrically conducting parts of the drinking glass 1. It is precisely here that the lighting module 6 can be advantageously affixed by means of a circular adhesive on the drinking glass 1. The contact terminals 14, 14′ are thereby additionally covered with a conducting paste so as to improve the electrical conduction to the glass.

On the underside of the circuit board 7 is placed a known photovoltaic cell, in short, a solar cell 17, shown in FIGS. 2 and 4. The solar cell 17 has an electrically conducting connection with the battery 9 via the terminal contacts 10, 11 that contact the circuit board 7, and is used to charge the battery 9.

The charging of the battery 9 via the solar cell 17 can thereby basically take place with the natural and/or artificial ambient light, wherein the drinking glass 1 can then not be set on the standing base 5, but rather the solar cell 17 must be radiated with the ambient light. For example, the drinking glass 1 must be turned upside down.

The triggering circuit 8 preferably has a controller with a charging monitor to charge the battery 9 from the solar cell 17. Furthermore, in a known manner, a controller for the triggering and supply of the light-emitting diodes 12, 12′ is provided in the triggering circuit. The charging and triggering functions can also be carried out by a common controller.

Advantageously, the charging can take place in that the drinking glass 1 is set aside straight up on a light-transparent surface, under which is located a light that radiates upward, by means of which light energy is radiated onto the solar cell 17, wherein, advantageously, a charging station in accordance with the invention is formed. For example, the surface can be a glass bottom or a grid of a cabinet, shelf, or something similar, under which a light that radiates upward is incorporated. Alternatively, the drinking glass 1 can also be placed upside down in a [or] under a light radiating downward, for example, a light located on the underside of a shelf bottom of a cabinet, a shelf, or a counter, in order to radiate the solar cell 17 pointing upward.

In an alternative or additional embodiment, the charging device of the battery 9 can be formed not (only) by the solar cell 17, but rather can also have a secondary coil that is located in the lighting module 6 or on the drinking glass 1, which can be provided inductively with electrical energy via a primary coil of a charging station. For example, the primary coil is introduced into a surface on which the drinking glass 1 is placed, for example, a shelf bottom, a counter, or something similar. This has the advantage that the surface need not be transparent to light. Moreover, the primary coil can be located in such a way that it is invisible from the outside, so that it does not impair the shape of the surface. Preferably, the surface can thereby have poor electrical conductance or not conduct electrically at all, so as not to impair the inductive energy transfer between the coils.

If the glass container is not a drinking glass 1, but rather, for example, a vase, which is normally not touched very often, then instead of the contact-sensitive switching element 16, a manual switch can be used that is located, for example, on the underside of the circuit board 7 and that can be switched from the outside, with which the light-emitting diodes 12, 12″ can be switched on or off. In this case, no electrically conducting glass is needed. Also, instead of or in addition to the contact-sensitive switching element 16, a switching element that interacts with the liquid in the holding space 2 can be used, so as to turn on the light-emitting diodes 12, 12′ with the pouring in of the liquid.

Moreover, not only can the switching on and off of the light-emitting diodes 12, 12′ be triggered by the triggering circuit 8, but different triggerings are also carried out, for example, blinking, slow dimming up and dimming down, etc. Such triggering possibilities are known to the specialist and do not need to be explained in detail.

### REFERENCE SYMBOL LIST

1 Drinking glass
2 Holding space
3 Walls
4 Standing base
4a Bottom surface
5 Trough
6 Lighting module
7 Circuit board
8 Triggering circuit
9 Rechargeable battery
10 Negative terminal contact
11 Positive terminal contact
12, 12′ Light-emitting diodes
13, 13′ Terminal surfaces
14, 14′ Terminal contacts
15, 15′ Contact surfaces
16 Switching element
17 Solar cell

1-16. (canceled)

17. Glass container with a lighting module, which contains at least one illuminant and an electrical energy storage unit, which are connected to a triggering circuit for the activation of the illuminant, wherein a charging device for the charging of the electrical energy storage unit is provided in the glass container.

18. Glass container according to claim 17, wherein the charging device is a photovoltaic solar cell located in or on the glass container.

19. Glass container according to claim 17, wherein the charging device is a coil for the inductive transfer of electrical energy from another coil of a charging station located outside the glass container.

20. Glass container according to claim 17, wherein the lighting module is integrated into the glass container.

21. Glass container according to claim 17, wherein the lighting module is integrated water-tight into the glass container.

22. Glass container according to claim 17, wherein the glass container is a drinking glass or a vase with a standing base and a lighting module integrated therein.

23. Glass container according to claim 22, wherein the charging device is a photovoltaic solar cell located in the standing base.

24. Glass container according to claim 23, wherein the solar cell points toward the underside of the standing base.

25. Glass container according to claim 17, wherein the glass container is made of electrically conductive glass or has electrically conductive contact surfaces, wherein for the activation of the illuminant(s), an electric circuit can be closed comprising the illuminants, triggering circuit, and the electrical energy storage unit by touching the glass container with at least one body part of a user of the glass container.

26. Glass container according to claim 25, wherein the contact surfaces are separated electrically from one another, and each contact surface is connected separately with the triggering circuit.

27. Glass container according to claim 26, wherein the contact surfaces surround walls of the glass container and have teeth like a comb that mesh into one another.

28. Glass container according to claim 26, wherein the contact surfaces are half-cylinders running halfway around walls and/or the standing base of the glass container.

29. Glass container according to claim 25, wherein electrically conductive particles are admixed with the glass.

30. Charging station for a glass container according to claim 17, wherein the charging station has an energy transfer device for the transfer of energy to the charging device of the glass container.

31. Charging station according to claim 30, wherein the charging device is a photovoltaic solar cell located in or on the glass container and wherein the energy transfer device has a lighting unit for the radiation of the solar cell of the glass container, located on the glass container.

32. Charging station according to claim 30, wherein the charging device is a coil for the inductive transfer of electrical energy from another coil of a charging station located outside the glass container and wherein the energy transfer device has a primary coil for the inductive transfer of electrical energy to the coil of the glass container.
